(19) United States
(12) Patent Application Publication
(10) Pub. No.: US 2011/0316859 A1
(43) Pub. Date: Dec. 29, 2011

(54) APPARATUS AND METHOD FOR DISPLAYING IMAGES

(75) Inventors: Jarmo Nikula, Jaali (FI); Jyrki Leskelä, Haukipudas (FI); Mika Salmela, Oulu (FI); Aki Happonen, Kiiminki (FI)

(73) Assignee: Nokia Corporation

(21) Appl. No.: 12/823,334

(22) Filed: Jun. 25, 2010

(51) Int. Cl. G06T 13/00; G06F 3/041

(52) U.S. Cl. 345/473; 345/173

(57) ABSTRACT

Apparatus and method for displaying images are provided. The apparatus is configured to cause a display of an image; detect one or more inputs by one or more input objects; determine coordinates of the one or more inputs in respect to the image; determine one or more property of the input; cause production of an animation with the image, the animation relating to the determined coordinates and being configured on the basis of one or more detected properties of the one or more inputs.

### FIELD

Embodiments of the invention relates to an apparatus and a method for displaying images.

### BACKGROUND

Touch screens are used as a display in many electronic devices, for instance in PDA (Personal Digital Assistant) devices, portable and laptop computers, and other mobile devices. Touch screens are operable by a pointing device (or stylus) and/or by a finger. Typically the devices also comprise conventional buttons or keyboard for certain operations.

Many electronic devices with a display are configured to display images. Some devices are equipped with a built-in camera and they may be configured to display images captured with the camera, other devices may be configured to display images received via Internet or other communication means.

### BRIEF DESCRIPTION

According to an aspect of the present invention, there is provided an apparatus comprising: at least one processor; and at least one memory including computer program code; at least one memory and the computer program code configured to, with the at least one processor, cause the apparatus at least to cause a display of an image; detect one or more inputs by one or more input objects; determine coordinates of the one or more inputs in respect to the image; determine one or more properties of the one or more inputs; and cause production of an animation with the image, the animation relating to the determined coordinates and being controlled on the basis of one or more detected properties of the one or more inputs.

According to an aspect of the present invention, there is provided an apparatus comprising: at least one processor; and at least one memory including computer program code; at least one memory and the computer program code configured to, with the at least one processor, cause the apparatus at least to cause a display of an image; receive information related to coordinates in respect to the image; and cause production of the animation with the image, the animation relating to the received coordinates.

According to another aspect of the present invention, there is provided a method comprising: causing a display of an image; detecting one or more inputs by one or more input objects; determining coordinates of the one or more inputs in respect to the image; determining one or more properties of the one or more inputs; and causing production of an animation with the image, the animation relating to the determined coordinates and being controlled on the basis of one or more detected properties of the one or more inputs.

According to another aspect of the present invention, there is provided a computer program embodied on a distribution medium, comprising program instructions which, when loaded into an electronic apparatus, control the apparatus to: cause a display of an image; detect one or more inputs by one or more input objects; determine coordinates of the one or more inputs in respect to the image; determine one or more properties of the one or more inputs; and cause a production of an animation with the image, the animation relating to the determined coordinates and being controlled on the basis of one or more detected properties of the one or more inputs.

### LIST OF DRAWINGS

Embodiments of the present invention are described below, by way of example only, with reference to the accompanying drawings, in which

FIG. 1 illustrates an example of an electronic device in accordance with an embodiment;

FIGS. 2A to 2D illustrate an embodiment of the invention;

FIGS. 3A and 3B are flowcharts illustrating embodiments of the invention;

FIGS. 4A to 4E illustrate an embodiment of the invention; and

FIGS. 5 and 6 are flowcharts illustrating embodiments of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

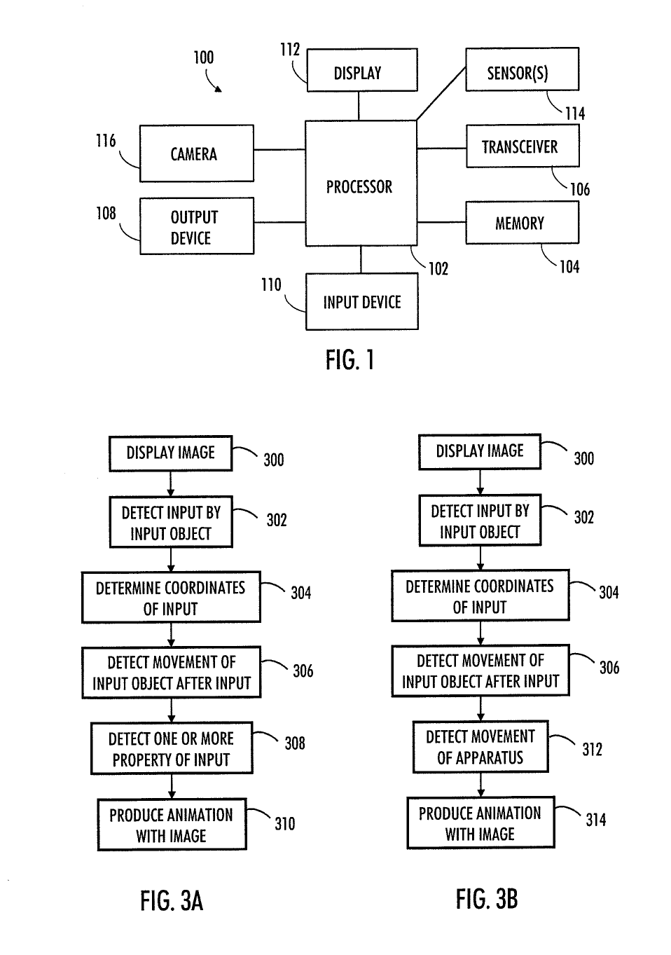

FIG. 1 illustrates an example of a block diagram of the structure of an electronic device 100 according to an example embodiment. Although one embodiment of the electronic device 100 is illustrated and will be hereinafter described for purposes of example, other types of electronic devices, such as, but not limited to, portable digital assistants (PDAs), pagers, mobile computers, desktop computers, laptop computers, Internet pads, media players, televisions, gaming devices, cameras, video cameras, video recorders, positioning devices, electronic book viewers, wearable devices, projector devices, and other types of electronic systems, may employ the present embodiments. Furthermore, the apparatus of an example embodiment need not be the entire electronic device, but may be a component or group of components of the electronic device in other example embodiments.

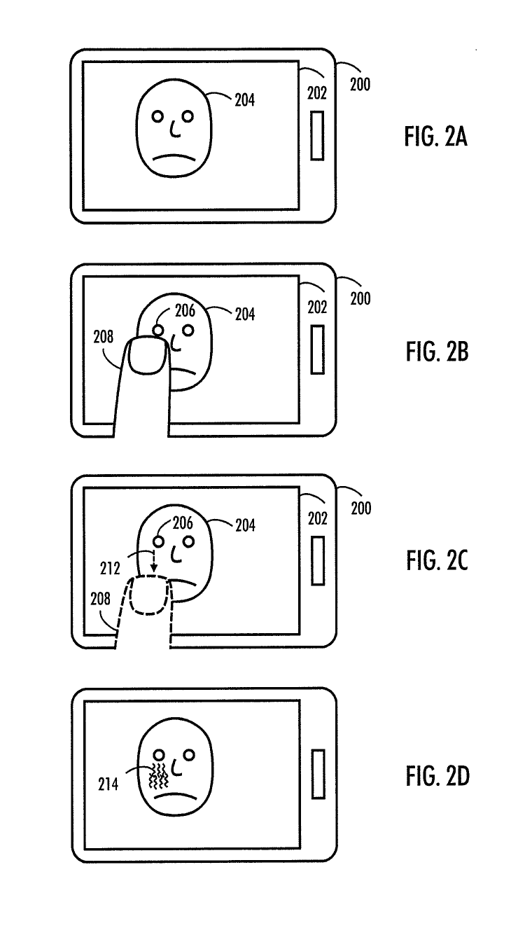

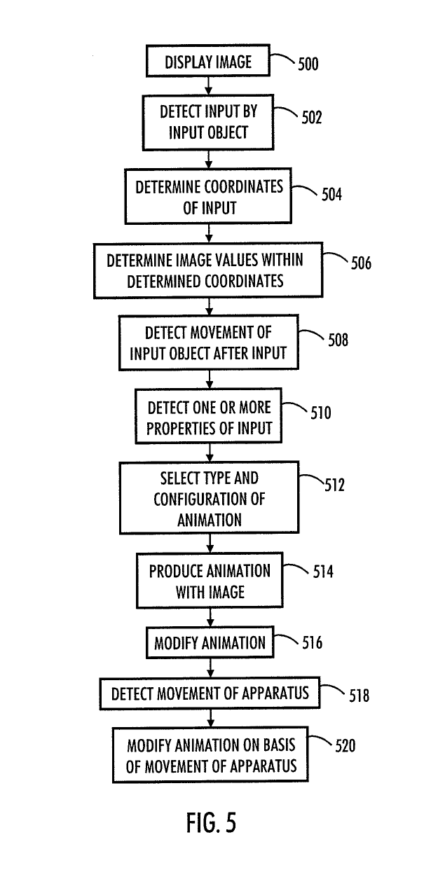

The electronic device of FIG. 1 comprises a processor 102 configured to execute instructions and to carry out operations associated with the electronic device 100. The processor 102 may comprise means, such as a digital signal processor device, one or more microprocessor device, and circuitry, for performing various functions described later in conjunction with FIGS. 2 to 6. The processor 102 may control the reception and processing of input and output data between components of the electronic device 100 by using instructions retrieved from memory. The processor 102 can be implemented on a single-chip, multiple chips or multiple electrical components. Some examples of architectures which can be used for the processor 102 include dedicated or embedded processor, and ASIC (application-specific integrated circuit).

The processor 102 may comprise functionality to operate one or more computer programs. Computer program code may be stored in a memory 104. The at least one memory and the computer program code may be configured to, with the at least one processor, cause the apparatus to perform at least one embodiment including, for example, one or more of the functions described below in conjunction with FIGS. 2 to 6. Typically the processor 102 operates together with an operating system to execute computer code and produce and use data.

By way of example, the memory 104 may include non-volatile portion, such as electrically erasable programmable read only memory (EEPROM), flash memory or the like, and a volatile portion, such as a random access memory (RAM) including a cache area for temporary storage of data. The information could also reside on a removable storage medium and loaded or installed onto the electronic device 100 when needed. The memory 104 may comprise one or more memory circuitries and it may be partially integrated with the processor 102.

The electronic device 100 may comprise a transceiver 106 comprising a transmitter and a receiver. An antenna (or multiple antennae) may be connected to the transceiver. The electronic device 100 may operate with one or more air interface standards and communication protocols. By way of illustration, the electronic device 100 may operate in accordance with any of a number of first, second, third and/or fourth-generation communication protocols of cellular systems or the like. For example, the electronic device 100 may operate in accordance with wire line protocols, such as Ethernet and digital subscriber line (DSL), with second-generation (2G) wireless communication protocols, such as IS-136 (time division multiple access (TDMA)), Global System for Mobile communications (GSM), and IS-95 (code division multiple access (CDMA)), with third-generation (3G) wireless communication protocols, such as 3G protocols by the Third Generation Partnership Project (3GPP), CDMA2000, wideband CDMA (WCDMA) and time division-synchronous CDMA (TD-SCDMA), with fourth-generation (4G) wireless communication protocols, such as the Long Term Evolution (LTE) Advanced protocols, wireless local area networking protocols, such as 802.11, short-range wireless protocols, such as Bluetooth, and/or the like. The processor 102 may control the transceiver 106 to connect to another (source or target) communications device and communicate with the other communications device by using a data transfer service provided by the transceiver 106.

The user interface of the electronic device 100 may comprise an output device 108, such as a speaker, one or more input devices 110, such as a microphone, a keypad or one or more buttons or actuators, and a display 112 for displaying information in two or more dimensions.

The input device 110 may include a touch sensing device configured to receive input from a user's touch and to send this information to the processor 102. Such touch-sensing device may be configured to recognize also the position and magnitude of touches on a touch sensitive surface. The touch sensing device may be based on sensing technologies including, but not limited to, capacitive sensing, resistive sensing, surface acoustic wave sensing, pressure sensing, inductive sensing, and optical sensing. Furthermore, the touch sensing device may be based on single point sensing or multipoint sensing. In an embodiment, the input device is a touch screen, which is positioned in front of the display 112. The input device 110 may be configured to provide information on movement of an input object on an input surface of the input device 110 for the processor 102. The touch sensing device may be configured to detect an input object, such as a finger or a stylus, without an actual contact with the input object. In such cases the device may comprise a proximity detection system or unit configured to detect when an input object is brought in close proximity to, but not in contact with, the touch sensing device.

The display 112 could be of any type appropriate for the electronic device 100 in question, some examples include plasma display panels (PDP), liquid crystal display (LCD), light-emitting diode (LED), organic light-emitting diode displays (OLED), projectors, holographic displays and the like.

The electronic device 100 may comprise one or more sensors 114 for enabling the device to detect changes in the orientation or movement of the device. The sensor may be inertial positioning sensors (accelerometer, gyroscope) or magnetometer, for example.

The electronic device 100 may comprise a media capturing element, such as a camera 116, configured to capture images or photos. The processor 102 may be configured to store captured images or photos in memory and display images on the display 112. The processor may be configured to store images received with the transceiver 106 in memory and display received images on the display 112.

The electronic device 100 may comprise also further units and elements not illustrated in FIG. 1, such as further interface devices, a battery, media capturing elements, video and/or audio module, and a user identity module.

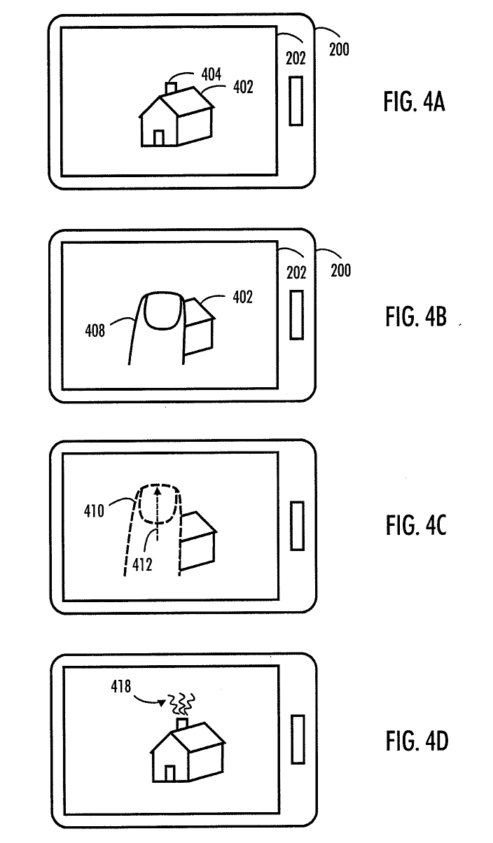

FIGS. 2A to 2D illustrate an embodiment applied to an electronic device 200. Reference is also made to FIG. 3A illustrating a method, which may be carried out as a control procedure in the electronic device 200, for instance.

The electronic device 200 of FIG. 2A comprises a display 202. The device 200 is configured to cause a display 300 of an image. In this example, the image shows a sad looking face 204. The image can also be live image, e.g. a video or camera viewfinder.

The device 200 is configured to detect 302 an input by an input object. In this example, the user of the device touches the left eye 206 of the face 204 in the image with a finger 208. The user may also use a stylus or other suitable object as an input object.

The electronic device 200 is further configured to determine 304 coordinates of the input in respect to the image. The coordinates may be x, y coordinates related to the displayed image. In an embodiment, the device comprises a touch screen on top of the display and the coordinates registered by the touch screen map directly to the coordinates of the display and the image. In some embodiments, the touch sensing device is not on top of the image and may be of different size compared to the display. In those cases the device is configured to map the coordinates of the touch sensing device to the coordinates of the display and the image so that there exists clear correspondence with the coordinates of the touch sensing device and the display. The coordinates may also include third dimension (z) in case of three-dimensional input device. For example, third dimension may be interpreted from the touch force in case of touch screen.

The electronic device 200 may be configured to detect 306 subsequent movement 212 of the input object. The electronic device 200 may be further configured to detect 308 one or more properties of the input. Examples of the properties are: touch force (or pressure), touch area shape and size (a sharp pen versus finger, for example), duration, movement direction, movement speed, gesture (movement shape), multi-touch (with two fingers, for example) and double-clicking meaning two subsequent rapid touches. For example, a property may be described as “moved 10 millimeters downwards in one second”.

The electronic device 200 is further configured to cause production 310 of an animation 214 on top of the image, the animation being related to the determined coordinates. The animation is based on the detected properties of the input and the animation may be controlled or configured by further input. The animation's relation to the determined coordinates may be e.g. such that animation originates from the coordinates or animation vanishes towards the coordinates. Other kinds of relations are also possible, e.g. animation may circulate around the coordinates.

In the example of FIGS. 2A to 2D, the device produces an animation effect simulating water flow. The animation originates from the coordinates of the point where the touch of the input object was detected, e.g. from the left eye 206 of the face 204 in the image. The water flow is directed towards the direction 212 where the input object was moved.

The flowchart of FIG. 3B illustrates another embodiment applied to an electronic device 200.

The blocks 300 to 306 are similar to the example of FIG. 3A.

In block 312, the electronic device 200 is configured to detect movement of the electronic device. The user may move or tilt the apparatus.

In block 314, the device is configured to cause production of an animation with the image, the animation relating to the determined coordinates and being configured on the basis of the detected movement of the apparatus.

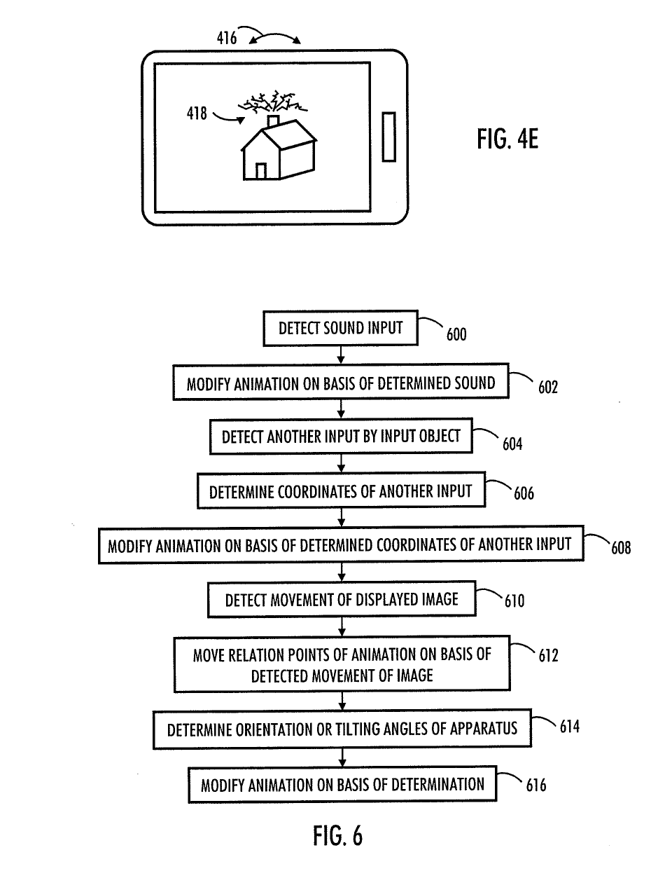

FIGS. 4A to 4E illustrate an embodiment applied to an electronic device 200. Reference is also made to FIG. 4 illustrating a method, which may be carried out as a control procedure in the electronic device 200, for instance.

The electronic device 200 of FIG. 4A comprises a display 202. The device 200 is configured to cause a display 500 of an image. In this example, the image shows a house 402 with a chimney 404 on the roof of the house.

The device 200 is configured to detect 502 an input by an input object. In this example, the user of the device touches the chimney 404 of the house 402 in the image with a finger 408. The user may also use a stylus or other suitable object as an input object.

The electronic device 200 is further configured 504 to determine coordinates of the input in respect to the image. The coordinates may be x, y coordinates related to the displayed image.

In an embodiment, the electronic device is configured to determine 506 image values within the determined coordinates. The image values may be e.g. pixel values in case of a pixel image or the information contained in vector data in case of a vector image.

The electronic device 200 is configured to detect 508 subsequent movement 410 of the input object.

In block 510, one or more properties of the input are detected. The properties may include the direction 412 of the subsequent movement of the object, for example.

In an embodiment, the electronic device is configured to select 512 the type and configuration of the animation on the basis of the detected direction 412 of movement. For example, a downward direction may produce an animation resembling flowing liquid such as water, while an upward direction may produce an animation resembling fume or smoke rising upwards from the determined point of origin. Horizontal directions may produce other animation effects. In general, the detected properties of the input may be applied in the configuration of the animation. For example, a slow movement of the input object may produce a thick dark smoke whereas a quick movement may produce light fog.

In the example of FIGS. 4A to 4E, the detected direction is upwards and the device is configured to produce 514 smoke animation 418 on top of the image on the basis of the direction. The animation originates from the determined coordinates, e.g., the chimney. The animation is directed to the detected direction of movement, e.g., upwards.

The origination point of the animation may further be adjusted based on image analysis. In an embodiment, the electronic device is configured to determine values of areas of the image related to the determined coordinates and execute computation with the values. The relation of the determined areas to the coordinates may be such that the areas are nearby to the coordinates, or that colors of the determined areas are of the same color than the area nearby the coordinates. For example, touching a black area causes all black areas to be determined. The relationship may also be some other, e.g. all areas containing similar information can be determined: touching a single eye causes all eyes to be determined, for example. The animation may be configured on the basis of the computation. The nearby area may be defined as 0 to 10% of the total image width or image height, for example.

In the computation, the device may analyze the image content. For example, in the examples of FIGS. 4A to 4E, where the selected animation is smoke, the electronic device may be configured to analyze the image nearby the determined point and detect that a top edge of a chimney is within the analyzed area. The smoke animation may originate from the top of the chimney although the determined point might be few pixels away from the top of the chimney.

In an embodiment, the electronic device is configured to modify 516 the animation on the basis of the image values determined in block 506. A computation may be executed using these values to determine the average color or size of an object within the determined area, for example. In an embodiment, the colour of the animation may be selected on the basis of the determined average color, or the amount of emitted smoke may depend on the size of a chimney.

In an embodiment, the electronic device is configured to determine the colour of the image in different parts of the image for example in block 500 while displaying the image. The device may be further configured to modify the animation in different parts of the image on the basis of the determined colour in block 516. For example, a liquid colour may be based on the colour of surroundings of the touched pixels. In addition, the smoke or fluid animation may be modified to go around any dark or light areas in the image.

In an embodiment, the electronic device is configured to detect 518 movement 416 of the device. The device may be further configured to modify 520 the animation on the basis of the detected movement. For example, the user may tilt 416 the electronic device and the device is configured to control the animation such that the smoke always rises upwards or liquid flows downwards. In FIG. 4E the shaking of the device causes the smoke to disperse 418.

FIG. 6 is a flowchart illustrating further embodiments. Although in the example embodiments of FIG. 6 have been described as consecutive operations the embodiments are not related to each other and may be executed independently, as one skilled in the art is aware.

In block 600, the electronic device is configured to detect a sound input. Referring to FIG. 1, the detection may be performed by input device 110, such as a microphone.

In block 602, the electronic device is configured to modify the animation on the basis of the determined sound. For example, blowing to the microphone of the device could cause smoke animation to disperse or disappear. In an embodiment, the device may determine the direction of the sound or blow with a stereo microphone and change the direction of the animation on the basis of the sound direction.

In block 604, the electronic device is configured to detect another input by an input object and determine the coordinates of another input in respect to the image in block 606. The device may also detect properties of another input in similar manner as with the first input.

In block 608, the electronic device is configured to modify the animation on the basis of the determined coordinates and possible properties of another input. For example, a liquid could be animated to flow towards the determined coordinates with possibly soaking away on the way.

In general, the device may be configured to detect one or more inputs of one or more input objects and control the animation on the basis of the properties of the one or more inputs. For example, multiple touches may be detected simultaneously or successively and the animation may be configured on the basis of the properties of the detected inputs.

In block 610, the electronic device is configured to detect movement of the image in the display 112. This may be the case when the display is a viewfinder of a camera and the changes according to camera movement. In block 612, the device is configured to move set relation points of animation on the basis of the detect movement of the image. Thus, if the animation is shown originating from a given detail in the image, and the detail moves in the display as camera is moved, the animation follows the movement of the image and seems to originate continuously from the same detail although the coordinates of the detail change. In an embodiment, the movement of the animation is based on the encoder of the camera.

In block 614, the electronic device is configured to determine the orientation or tilting angle of the device. The determination may be based on the movement of the device, for example.

In block 616, the electronic device is configured to modify the animation on the basis of the determination.

In an embodiment, a user may select the type of the animation from a menu comprising a list of possible animation types. In this embodiment, the same animation type is produced regardless of the detected properties of the input. In an embodiment, the user may select from a menu the animation type each direction produces. Thus, the selection of the animation types may be customized according to each user's needs.

Examples of possible animations are smoke, water, small marbles, sand, coloured gas, fire, liquids of different viscosity or user selectable image. In an embodiment, the animation may comprise three-dimensional features, such as water flowing away from the viewer towards a distant horizon.

In an embodiment, the electronic device may be configured to select and/or modify animation on the basis of image processing techniques. For example, the device may analyze the image and determine that the image portrays a face with an angry expression. The device may be configured to produce smoke animation on the basis of the determination. Furthermore, the origination point of the smoke may also be based on the face detection. In this embodiment, e.g. a picture of winter landscape could produce snowfall animation and summer landscape could produce rain animation.

In an embodiment, the electronic device may be configured to produce several animation effects simultaneously. The user may initiate an animation and initiate a second animation while the previous animation is still visible. The animations may be of different types, such as smoke and water together. Basically only the processing power of the device sets a practical limit to the number of concurrent animations.

In an embodiment, the device is configured to create a transparent or partially transparent layer on top of the displayed image. The animation may be produced on the transparent layer so that the actual image is not changed. The image and the animation layer may also be mixed together to produce e.g. waving effect that imitates image viewed through waving water surface. The mixing may include e.g. summing, multiplying or shifting pixel positions based on to the image values and animation layer values. It is also possible to use several layers.

The animation may be produced with suitable animation algorithms. For example, smoke animation may be based on a known “stable fluids”-algorithm. The algorithm generates a smoke density matrix that can then be used for several kinds of visualizations. The position of the device may be taken into consideration, so that the smoke rises upwards. When the user tilts the device the direction of the smoke changes accordingly. This produces realistic feeling of live smoke.

In an embodiment, the smoke density matrix is used to generate a pixel texture that is further scaled to match the photo image size and used to adjust that underlying photo. Depending on the smoke density, the photo's pixels are both adjusted towards white and shifted a bit horizontally and vertically to produce waving effect that imitates hot air.

Water or liquid simulation may be based on so called Smoothed Particle Hydrodynamics (SPH) that is a well-known technique. SPH may be scaled down to be suitable for low-performance device such as mobile phones. Examples of the operations for visualizing water on top of an image are:

1. Simulate particles using SPH. The position of the device is taken into account so that tilting of the device makes the particles to move into correct direction according to real gravity.

2. Each particle is written onto a low-resolution matrix (200×120) as a box (2×2), where values of the matrix represent the pressure of that particle (given by SPH).

3. Filter a previously generated “pressure matrix” to get rid of small holes between particles.

4. Generate a derivative matrix of the filtered pressure matrix in order to imitate light refraction caused by natural water surface. The tilting angle of the device may be taken into consideration again and changing reflections are generated based on that. In addition, offsets of the refractions are based on the tilting angle of the device so that the underlying image will shift according to the tilting of the device.

5. Use a previously generated “refraction matrix with reflections” as a texture to be combined with the original photo. At this phase, the texture is scaled to match the image size and used to adjust values and positions of the pixels of the image according to the refraction/reflection matrix.

In an embodiment, the electronic device is configured to store information related to one or more inputs, the information comprising a relation to the image displayed while the one or more inputs were detected. Referring to FIG. 1, the processor 102 may store the information to the memory 104, for example. This feature enables viewing the same animation effects on top of the same image later. The stored information may comprise the position where the animation starts from (as x/y-coordinates), the selected animation (smoke, water, etc), and/or the direction of the animation, for example. The stored information may comprise the detected properties of the input. The information may comprise data related to more than one animation which are displayed with the same image.

Some image formats such as jpg or jpeg (Joint Photographic Experts Group), tiff (Tagged Image File Format) and exif (Exchangeable image file format) enable the inclusion of extra information into an image file. The information may be included in the image file as metadata tags, for example.

In an embodiment, the information related to animation effects is stored as metadata in the image file. When such image file is displayed by the electronic device the device may automatically start the animation that is specified in the file.

In another embodiment, the information related to animation effects is stored to a file separate from the image file it is associated with. In an embodiment, the name of the information file may be the same as the photo file name but with different extension. For example, if the image is myphoto.jpg the information file might be named as myphoto.anim. The information file might contain following fields: “x=112 y=225 anim=smoke”, for example.

In another embodiment, the information related to animation effects is stored to a centralized file or database to collect animation information for all images. In such a case, the stored information comprises reference to the image with which the information is associated.

In an embodiment, the electronic device is configured to transmit information related to one or more inputs to another device, the information comprising a relation to the image displayed while the one or more inputs were detected.

The proposed embodiment enables sharing the same image viewing experience with a group of people. Typically, a group of people sitting together (in a party, for example) may share a set of images, each participant viewing the same image displayed by his/her own device. A user starts an animation by touching a device. The user's device may be configured to send the information related to the animation to the devices of the other participants.

Referring to FIG. 1, processor 102 of the electronic device 100 may be configured to control the display 112 to display an image. In an embodiment, the image is received with the transceiver 106 from another device. The processor controls the transceiver to receive information related to coordinates in respect to the image and information related to type and configuration of an animation.

The processor controls the device to cause production of the animation on the display with the image, the animation being related to the received coordinates, the animation being based on the received information and/or the type of the animation.

In an embodiment, the received information comprises all information related to the animation. The information may also contain the image that is being animated.

In an embodiment, the processor may be configured to modify the animation based on received information from the user of the device. The processor may be configured to modify the animation based on detected movement or tilting angle of the device. Thus, a user may modify an animation received from another device.

In an embodiment, the animation control may be applied to transition effects between two images. In the embodiment, the user makes the decision from where the transition begins. In other words, e.g. touching over a funnel would produce smoke, and the next photo would appear smoothly with that smoke.

The electronic device 100 may be implemented as an electronic digital computer, which may comprise a working memory (RAM), a central processing unit (CPU), and a system clock. The CPU may comprise a set of registers, an arithmetic logic unit, and a control unit. The CPU may be a dual-core or multiple-core processor. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembly language. The electronic digital computer may also have an operating system, which may provide system services to a computer program written with the program instructions.

An embodiment provides a computer program embodied on a distribution medium, comprising program instructions which, when loaded into an electronic apparatus, execute the method described above in connection with FIGS. 2 to 6.

The computer program may be in source code form, object code form, or in some intermediate form, and it may be stored in some sort of carrier, which may be any entity or device capable of carrying the program. Such carriers include a record medium, computer memory, read-only memory, and software distribution package, for example. Depending on the processing power needed, the computer program may be executed in a single electronic digital computer or it may be distributed amongst a number of computers.

The operations described above in FIGS. 3, 5, and 6 are in no absolute chronological order, and some of the operations may be performed simultaneously or in an order differing from the given one. Other functions can also be executed between the operations or within the operations. Some of the operations or part of the operations can also be left out or replaced by a corresponding operation or part of the operation.

An embodiment provides an apparatus comprising: at least one processor; and at least one memory including computer program code; at least one memory and the computer program code configured to, with the at least one processor, cause the apparatus at least to cause a display of an image; detect one or more inputs by one or more input objects; determine coordinates of the one or more inputs in respect to the image; determine movement of the apparatus; and cause production of an animation with the image, the animation relating to the determined coordinates and being controlled on the basis of the detected movement of the apparatus.

An embodiment provides an apparatus, comprising means for causing a display of an image; means for detecting one or more inputs by one or more input objects; means for determining coordinates of the one or more inputs in respect to the image; means for determining one or more properties of the one or more inputs; and means for causing production of an animation with the image, the animation relating to the determined coordinates, and being configured on the basis of one or more detected properties of the one or more inputs.

An embodiment provides an apparatus, comprising means for causing a display of an image; means for detecting one or more inputs by one or more input objects; means for determining coordinates of the one or more inputs in respect to the image; means for determining movement of the apparatus; and means for causing production of an animation with the image, the animation relating to the determined coordinates, and being configured on the basis of the detected movement of the apparatus.

Another embodiment provides an apparatus, comprising means for causing a display of an image; means for receiving information related to coordinates in respect to the image; and means for causing production of the animation with the image, the animation relating to the received coordinates.

Another embodiment provides a method comprising: causing a display of an image; detecting one or more inputs by one or more input objects; determining coordinates of the one or more inputs in respect to the image; determining movement of the apparatus; and causing production of an animation with the image, the animation relating to the determined coordinates and being controlled on the basis of the detected movement of the apparatus.

Another embodiment provides a method comprising: causing a display of an image; receiving information related to coordinates in respect to the image; and causing production of the animation with the image, the animation relating to the received coordinates.

It will be obvious to a person skilled in the art that, as technology advances, the inventive concept can be implemented in various ways. The invention and its embodiments are not limited to the examples described above but may vary within the scope of the claims.

1. An apparatus comprising:
at least one processor;
and at least one memory including computer program code;
at least one memory and the computer program code configured to, with the at least one processor, cause the apparatus at least to
cause a display of an image;
detect one or more inputs by one or more input objects;
determine coordinates of the one or more inputs in respect to the image;
determine one or more properties of the one or more inputs; and
cause production of an animation with the image, the animation relating to the determined coordinates and being controlled on the basis of one or more detected properties of the one or more inputs.

2. The apparatus of claim 1, wherein the apparatus is configured to
detect movement of the apparatus; and
modify the animation on the basis of the movement of the apparatus.

3. The apparatus of claim 1, wherein the apparatus is configured to determine the orientation or tilting angles of the apparatus and modify the animation on the basis of the determination.

4. The apparatus of claim 1, wherein the apparatus is configured to
determine the image values in different parts of the image;
execute computation with the image values; and
modify the animation on the basis of the computation.

5. The apparatus of claim 1, wherein the apparatus is configured to
detect a sound input; and
modify the animation on the basis of the determined sound.

6. The apparatus of claim 1, wherein the apparatus is configured to
store information related to one or more inputs, the information comprising a relation to the image displayed while the one or more inputs were detected.

7. The apparatus of claim 1, wherein the apparatus is configured to
transmit information related to one or more inputs to another device, the information comprising a relation to the image displayed while the one or more inputs were detected.

8. The apparatus of claim 1, wherein the apparatus is further configured to
receive information related to coordinates in respect to the image; and
produce the animation with the image, the animation relating to the received coordinates.

9. The apparatus of claim 8, wherein the apparatus is further configured to
receive information containing the configuration of the animation and configure the animation according to the received configuration.

10. The apparatus of claim 8, wherein the apparatus is further configured to
detect movement of the apparatus; and
modify the animation on the basis of the movement of the apparatus.

11. A method comprising:
causing a display of an image;
detecting one or more inputs by one or more input objects;
determining coordinates of the one or more inputs in respect to the image;
determining one or more properties of the one or more inputs; and
causing production of an animation with the image, the animation relating to the determined coordinates and being controlled on the basis of one or more detected properties of the one or more inputs.

12. The method of claim 11, further comprising:
detecting movement of the apparatus; and
modifying the animation on the basis of the movement of the apparatus.

13. The method of claim 11, further comprising:
detecting a sound input; and
modifying the animation on the basis of the determined sound.

14. The method of claim 11, further comprising:
storing information related to one or more inputs, the information comprising a relation to the image displayed while the one or more inputs were detected.

15. The method of claim 11, further comprising:
transmitting information related to one or more inputs to another device, the information comprising a relation to the image displayed while the one or more inputs were detected.

16. The method of claim 11, further comprising:
receiving information related to coordinates in respect to the image; and
producing the animation with the image, the animation relating to the received coordinates.

17. The method of claim 16, further comprising:
receiving information containing the configuration of the animation and configuring the animation according to the received configuration.

18. A computer program embodied on a distribution medium, comprising program instructions which, when loaded into an electronic apparatus, control the apparatus to:
cause a display of an image;
detect one or more inputs by one or more input objects;
determine coordinates of the one or more inputs in respect to the image;
determine one or more properties of the one or more inputs; and
cause production of an animation with the image, the animation relating to the determined coordinates and being controlled on the basis of one or more detected properties of the one or more inputs.

19. The computer program of claim 18, further controlling the apparatus to: detect movement of the apparatus; and
modify the animation on the basis of the movement of the apparatus.

20. The computer program of claim 18, further controlling the apparatus to: determine the orientation or tilting angles of the apparatus and modify the animation on the basis of the determination.
